(19) United States
(12) Patent Application Publication
(10) Pub. No.: US 2015/0032917 A1
(43) Pub. Date: Jan. 29, 2015

(54) MULTIPLEXER FOR SIGNALS ACCORDING TO DIFFERENT PROTOCOLS

(71) Applicant: Vincent Nguyen, Houston, TX (US)

(72) Inventor: Vincent Nguyen, Houston, TX (US)

(21) Appl. No.: 14/366,390

(22) PCT Filed: Feb. 22, 2012
(86) PCT No.: PCT/US2012/026066

§ 371 Date: Jun. 18, 2014

(51) Int. Cl. G06F 13/28; G06F 13/40

(52) U.S. Cl. CPC G06F 13/287; G06F 13/4022; G06F 2213/4004; G06F 2213/2804
USPC 710/51; 710/316; 710/313

(57) ABSTRACT

A multi-protocol multiplexer provides signals according to different protocols for accessing a storage subsystem to a connector, where the signals according to a first protocol are to be routed over a first subset of channels of an interconnect to the storage subsystem, and the signals according to a second protocol are routed over a second subset of channels of the interconnect.

### BACKGROUND

A system can include storage devices that support different input/output (I/O) technologies. To access the storage devices according to different I/O technologies, multiple interconnects (e.g. cables) can be used to communicate control signals and data signals with the different storage devices.

### BRIEF DESCRIPTION OF THE DRAWINGS

Some embodiments are described with respect to the following figures:

FIG. 1 is a block diagram of an example system that includes a multi-protocol multiplexer according to some implementations;

FIGS. 2A and 2B are block diagrams of multi-protocol multiplexers according to various implementations; and

FIG. 3 is a flow diagram of a process according to some implementations.

### DETAILED DESCRIPTION

A system can include different types of storage devices (e.g. disk-based storage devices, integrated circuit storage devices, and so forth) that operate according to different input/output (I/O) technologies. In such system, storage controllers can be connected with the different storage devices using different interconnects (e.g. cables, printed circuit boards, etc.). For example, a first cable can be used to connect a first storage controller to storage device(s) that operate(s) according to a first I/O technology, and a second cable can be used to connect a second storage controller to storage device(s) that operate(s) according to a second, different I/O technology. The storage controllers that operate according to different I/O technologies employ control signals and data signals according to different protocols. In some examples, the first protocol can be one of an SAS (Serial Attached System Computer System Interface) protocol or an SATA (Serial Advanced Technology Attachment) protocol. The SAS protocol provides a point-to-point, serial interface to move data between an electronic device and a storage device. The SATA protocol also provides a serial interface between an electronic device and a storage device.

In some examples, the second protocol can be a PCIe (Peripheral Component Interconnect Express) protocol. PCIe provides a point-to-point topology to communicate control and data over a serial link.

Although reference is made to specific example protocols, it is noted that other types of protocols can be used in other implementations.

In some examples, storage controllers can be provided as part of a controller subsystem (e.g. part of a motherboard or main board), while storage devices can be provided as part of a storage subsystem separate from the first subsystem. Each of the controller subsystem and storage subsystem can be provided with multiple connectors, with a first connector to connect a storage controller that supports a first I/O technology with corresponding first storage device(s), and a second connector to connect a storage controller that supports a second, different I/O technology with corresponding second storage device(s).

Using multiple different connectors and corresponding different interconnects for establishing connections between storage controllers that support different I/O technologies with respective storage devices can increase interconnect complexity and can lead to increased parts costs associated with a system.

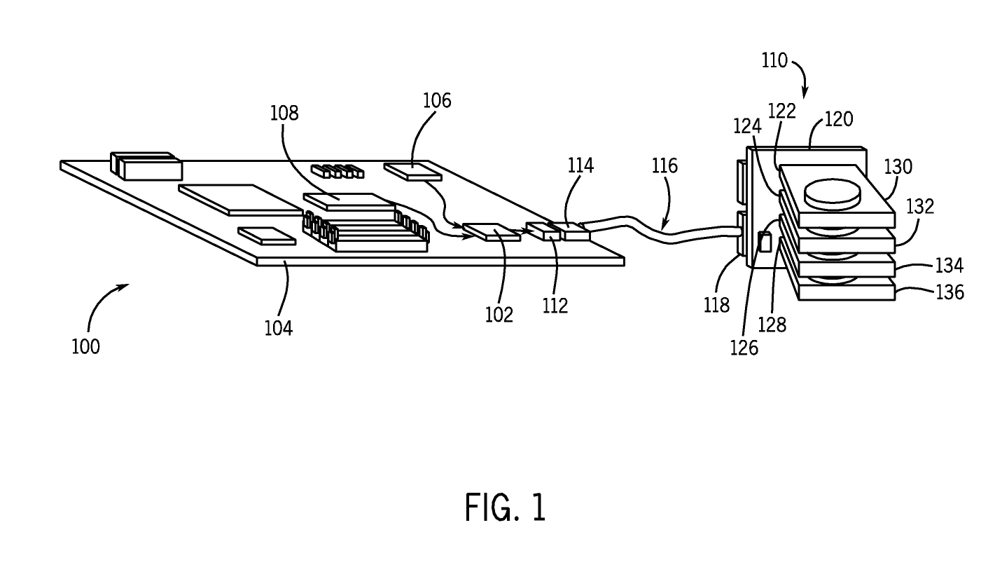

FIG. 1 illustrates an example system 100 that employs a multi-protocol multiplexer 102 according to some implementations. The multiplexer 102 can be implemented with an integrated circuit device, such as a microcontroller, application-specific integrated circuit (ASIC), programmable gate array (PGA), microprocessor, and so forth.

The multi-protocol multiplexer 102 is arranged on a main board (or motherboard) 104, which also has a first storage controller 106 and a second storage controller 108. In other implementations, the first and second storage controllers 106 and 108 can be mounted on multiple boards instead of on the same main board. Also, although FIG. 1 depicts two storage controllers, it is noted that more than two storage controllers can be provided in other implementations. As further shown in FIG. 1, other devices can also be mounted on the main board 104, such as a processor, a memory device, and so forth.

The first storage controller 106 is able to communicate control signals and data signals with the multi-protocol multiplexer 102, and the second storage controller 108 is also able to communicate control signals and data signals with the multi-protocol multiplexer 102. In some implementations, the first storage controller 106 communicates control/data signals according to a first protocol, and the second storage controller 108 communications control/data signals according to a second, different protocol. The first and second storage controllers 106 and 108 thus support respective different input/output (I/O) technologies associated with accessing storage devices in a storage subsystem 110. The storage subsystem 110 is separate from the main board 104.

The multi-protocol multiplexer 102 routes the control/data signals from the first and second storage controllers to an interface of the multi-protocol multiplexer 102 that is connected to a connecter 112 on the main board 104. The connector 112 is connected to a mating connector 114 at a first end of an interconnect 116, which can be in the form of a cable (e.g. electrical cable or other type of cable), a printed circuit board, or other type of interconnect. The other end of the cable 116 has a mating connector 118 to connect to a corresponding connector of a storage backplane 120 of the storage subsystem 110. The storage backplane 120 can be a circuit board that has various slots 122, 124, 126, and 128 for receiving respective storage devices 130, 132, 134, and 136. In other examples, other types of support structures other than a backplane can be employed in the storage subsystem 110.

The multi-protocol multiplexer 102 is able to multiplex (selectively route) signals from different storage controllers (that operate according to different protocols) to the same connector 112, for communication to the storage subsystem 110 over the common interconnect 116. In the reverse direction (from the storage subsystem 110 to the storage controllers 106 and 108), the multi-protocol multiplexer 102 is able to direct signals received from one of the slots 122, 124, 126, and 128 over the interconnect 116 to a corresponding one of the storage controllers 106 and 108.

The interconnect 116 has multiple sets of channels or lanes to route corresponding signals to respective ones of the slots 122, 124, 126, and 128. A “channel” or “lane” of the interconnect 116 includes communication media (e.g. a pair of electrical wires to communicate a differential signal, or other type of communication media) to communicate a respective signal between the main board and a corresponding slot of the backplane 120.

Each of the multiple sets of channels of the interconnect 116 can include one channel or multiple channels, depending upon the configuration of the storage device in the corresponding slot 122, 124, 126, or 128. For example, if a storage device in a given slot has a x2 input/output configuration, then two channels would be included in the corresponding set.

By using the multi-protocol multiplexer 102 according to some implementations, a single interconnect 116 can be used to connect signals (control and data signals) according to different protocols to the storage subsystem 110. The storage devices 130, 132, 134, and 136 provided in respective slots 122, 124, 126, and 128 of the storage backplane 120 can operate according to different I/O technologies. For example, a first subset of the storage devices 130, 132, 134, and 136 can operate according to a first protocol, while another subset of the storage devices 130, 132, 134, and 136 operate according to a second, different protocol.

It is noted that over time, a user may change storage devices that are mounted in the corresponding slots. For example, the storage device 130 in the slot 122 may initially be a storage device that is according to a first I/O technology. Later, a user may replace the storage device 130 in the slot 122 with a different storage device that is according to a second I/O technology. The multi-protocol multiplexer 102 according to some implementations is able to detect the change of I/O technology in a given slot, and can reconfigure the multiplexer 102 accordingly to route signals according to the different protocol.

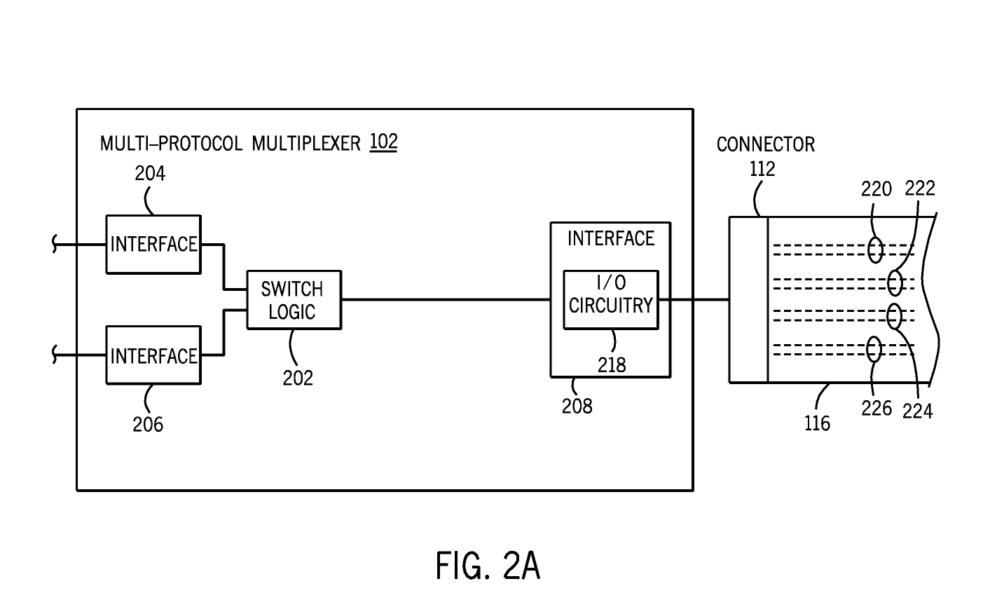

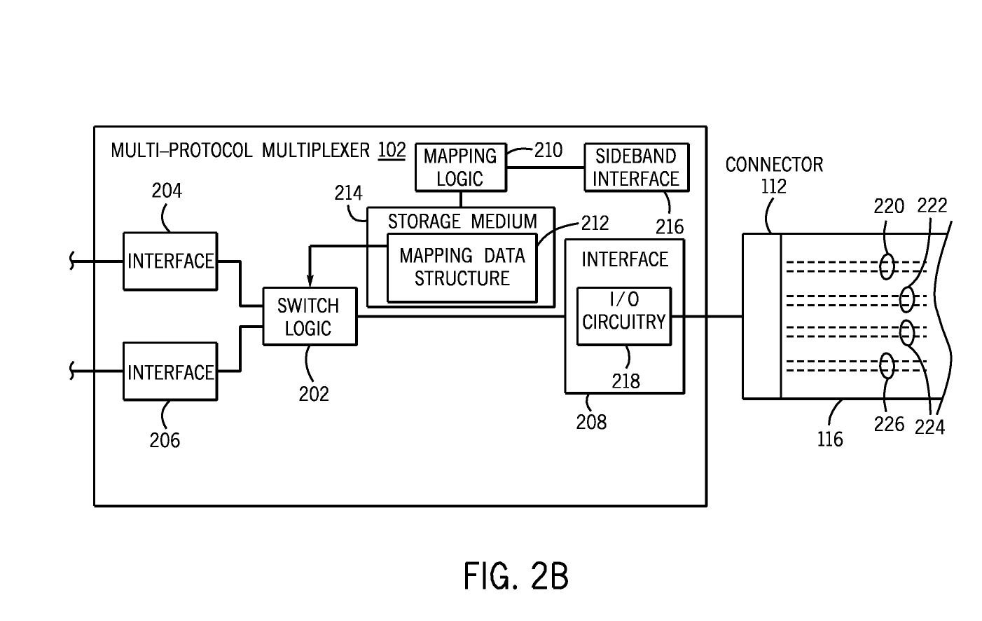

FIG. 2A is a block diagram of an example multi-protocol multiplexer 102 according to some implementations. The multi-protocol multiplexer 102 includes switch logic 202 that is connected to a first interface 204 and a second interface 206. The first interface 204 is to communicate signals (control and data signals) with the first storage controller 106, while the second interface 206 is to communicate signals (control and data signals) with the second storage controller 108. The switch logic 202 is further connected to another interface 208, which is connected to the connector 112 on the main board 104.

In the direction from storage controllers to the storage subsystem 110 of FIG. 1, the switch logic 202 is able to route signals received at the interfaces 204 and 206 to the interface 208, for provision to the connector 112. The interface 208 includes I/O circuitry 218 to route the signals to corresponding pins of the connector 112, such that the signals are communicated over respective sets 220, 222, 224, and 226 of channels in the interconnect 116. Assuming that the sets 220, 222, and 224 of channels are used to route signals according to a first protocol (e.g. SAS or SATA protocol) to corresponding storage devices, and the set 226 of channels is used to route signals according to a second protocol (e.g. PCIe protocol), then the switch logic 202 routes the signals according to the first protocol from the first storage controller 106 over the channels in the sets 220, 222, and 224, and routes the signals according to the second protocol from the second storage controller 108 over the channels in the set 226.

The I/O circuitry 218 in the interface 208 can be dynamically configured to output signals of the appropriate voltage and having the appropriate impedance of the corresponding I/O technology. For example, for channels in the sets 220, 222, and 224 of the cable 116, the I/O circuitry 218 provides signals having the appropriate voltage and impedance of a first I/O technology (e.g. according to the SAS or SATA protocol). On the other hand, for channels in the set 226 of the cable 116, the I/O circuitry 218 provides signals having the appropriate voltage and impedance of a second I/O technology (e.g. according to the PCIe protocol). More generally, the I/O circuitry 218 in the interface 208 can be dynamically configured to output signals having the appropriate characteristic defined by the corresponding I/O technology.

For signals communicated in the direction from the storage subsystem 110 to the storage controllers, the switch logic 202 is able to route signals received from corresponding sets of channels of the cable 116 to the corresponding interfaces 204 and 206.

Using the multi-protocol multiplexer 102, control/data signals according to different protocols can be communicated through the same connector 112 over the common interconnect 116 for communicating with the storage subsystem 110.

FIG. 2B illustrates the multi-protocol multiplexer 102 according to alternative implementations. The multiplexer 102 of FIG. 2B further includes mapping logic 210 that is able to detect types (I/O technologies) of storage devices mounted in the slots 122, 124, 126, and 128 (FIG. 1) of the storage system 110. The detection of the I/O technologies can be accomplished using data communicated through a sideband interface 216 of the multiplexer 102. The sideband interface 216 can communicate data over a sideband bus (e.g. I²C bus or other type of bus) with the storage subsystem 110. In other examples, data used for detecting I/O technologies of storage devices can be exchanged in-band with the cable 116. A “sideband bus” refers to a bus that is separate from the interconnect 116. In some examples, the sideband interface 216 can communicate with the storage system 110 through a management controller that is coupled to the sideband bus. In other examples, the sideband interface 216 can communicate directly with the storage system 110.

Based on the detected types of storage devices in the respective slots of the storage system 110, the mapping logic 210 can store a mapping data structure 212 (e.g. a mapping table or other type of data structure) in a storage medium 214 (e.g. flash memory, dynamic random access memory, static random access memory, etc.) in the multiplexer 102. The mapping data structure 212 contains information for mapping the different I/O technologies of storage devices to respective slots of the storage subsystem 110.

The information in the mapping data structure 212 can be used by the multi-protocol multiplexer 102 to configure the I/O circuitry 218 in the interface 208 to cause appropriate voltage levels and impedances to be provided for the different sets 220, 222, 224, and 226 of channels. For example, if the mapping data structure 212 indicates that the set 220 of channels is to route signals according to the first protocol, then the I/O circuitry 218 is configured to provide such signals at the voltage levels and impedances of the first protocol; one the other hand, if the mapping data structure 212 indicates that the set 226 of channels is to route signals according to the second protocol, then the I/O circuitry 218 is configured to provide such signals at the voltage levels and impedances of the second protocol.

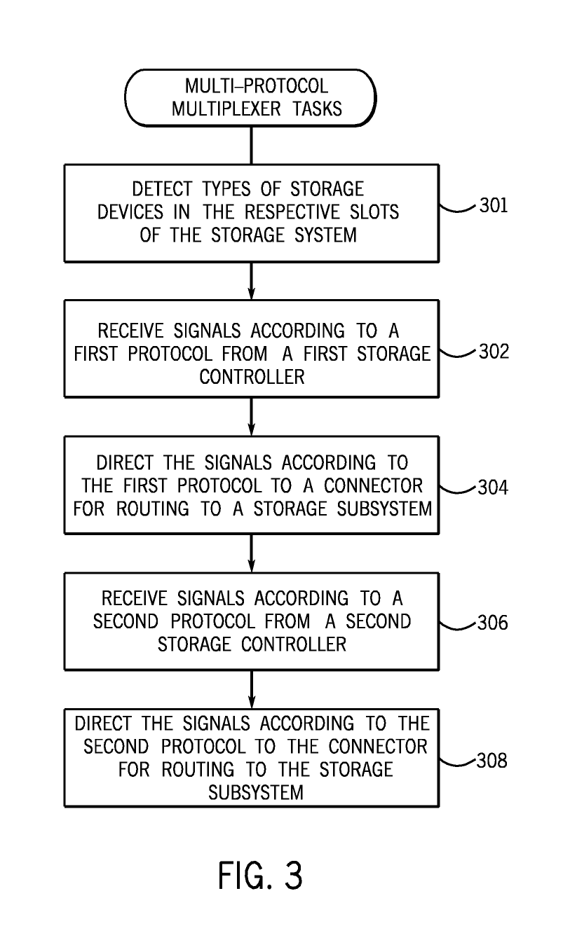

FIG. 3 is a flow diagram of a process of operation using the multi-protocol multiplexer 102 according to some implementations. Initially, the multi-protocol multiplexer 102 can detect (at 301) types of storage devices in the respective slots of the storage system 110. The detection can be accomplished over the sideband interface 216 (FIG. 2B) or through an inband interface. Based on the detection, the mapping data structure 212 (FIG. 2B) can be created or updated to store information mapping the different I/O technologies of storage devices to respective slots of the storage subsystem 110.

The multi-protocol multiplexer 102 receives (at 302) signals according to the first protocol from the first storage controller 106. The switch logic 202 directs (at 304) the signals according to the first protocol to the connecter 112, which routes the signals to the storage subsystem 110 over a first subset of the channels in the cable 116 (based on the information in the mapping data structure 212). These signals are used for accessing (reading or writing) data of storage device(s) according to a corresponding first I/O technology in the storage subsystem 110.

The multi-protocol multiplexer 102 can also receive (at 306) signals according to the second protocol from the second storage controller 108. The switch logic 202 directs (at 308) the signals according the second protocol to the connector 112, which routes the signals according to the second protocol over a second subset of the channels in the cable 116 (based on the information in the mapping data structure 212). These signals provided in the second subset of channels are used for accessing the data of storage device(s) according to a corresponding second I/O technology in the storage subsystem 110.

FIG. 1 depicts implementations in which the multi-protocol multiplexer 102 is separate from the storage controllers 106 and 108. In other implementations, the multi-protocol multiplexer 102 can be integrated into a storage controller. The storage controller can receive signals according to different protocols for accessing storage devices of different corresponding I/O technologies. The signals according to different protocols can be provided through the multi-protocol multiplexer integrated into the storage controller, for provision through a common connector to respective subsets of channels in a shared interconnect, in a manner similar to that described above.

Using the multi-protocol multiplexer according to some implementations, multiple I/O technologies such as PCIe and SAS or SATA can be consolidated for communication over a common interconnect to a storage subsystem.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A multi-protocol multiplexer, comprising:
a first interface to receive first signals according to a first protocol for accessing a storage subsystem;
a second interface to receive second signals according to a second, different protocol for accessing the storage subsystem; and
a switch logic to receive the first and second signals and to selectively:
output the first signals to a connector for routing over a first subset of channels in an interconnect that is connected to the storage subsystem, and
output the second signals to the connector for routing over a second subset of the channels in the interconnect.

2. The multiplexer of claim 1, further comprising input/output (I/O) circuitry to provide signals having a first characteristic to the first subset of channels and provide signals having a second, different characteristic to the second subset of channels.

3. The multiplexer of claim 2, wherein the first characteristic is at least one selected from a first voltage level and a first impedance, and the second characteristic is at least one selected from a second voltage level and a second impedance.

4. The multiplexer of claim 1, further comprising mapping logic to map slots of the storage subsystem to different input/output (I/O) technologies of corresponding storage devices in slots of the storage subsystem, wherein a storage device according to a first of the I/O technologies communicates signals according to the first protocol, and a storage device according to a second of the I/O technologies communicates signals according to the second protocol.

5. The multiplexer of claim 2, further comprising an interface to communicate data over a bus to identify the different I/O technologies of corresponding storage devices in the slots.

6. The multiplexer of claim 5, wherein the mapping logic is to generate a mapping data structure to map the slots to corresponding ones of the different I/O technologies.

7. The multiplexer of claim 6, wherein the I/O is configured according to the mapping data structure.

8. An apparatus comprising:
a first storage controller to provide first signals according to a first protocol for accessing a storage subsystem;
a second storage controller to provide second signals according to a second, different protocol for accessing the storage subsystem;
a connector to connect to an interconnect to the storage subsystem; and
a multi-protocol multiplexer to receive the first and second signals from the first and second storage controllers and to output the first signals and second signals to the connector, wherein the first signals are to be provided over a first subset of channels of the interconnect, and the second signals are to be provided over a second subset of channels of the interconnect.

9. The apparatus of claim 8, further comprising mapping logic to map slots of the storage subsystem to different input/output (I/O) technologies of corresponding storage devices in the slots, wherein a storage device according to a first of the I/O technologies communicates signals according to the first protocol, and a storage device according to a second of the I/O technologies communicates signals according to the second protocol.

10. The apparatus of claim 9, wherein the mapping logic is to communicate data over a sideband bus with the storage subsystem to identify the I/O technologies of the slots in the storage subsystem.

11. The apparatus of claim 9, wherein the multiplexer includes I/O circuitry connected to the connector, wherein the I/O circuitry is to be configured according to the mapping performed by the mapping logic.

12. The apparatus of claim 11, wherein the mapping logic is to detect a change of I/O technology of a storage device in a particular one of the slots, and the mapping logic is to cause a change in configuring the I/O circuitry according to the change of I/O technology.

13. The apparatus of claim 8, wherein the first protocol is one of an SAS (Serial Attached Small Computer System Interface) protocol and an SATA (Serial Advanced Technology Attachment) protocol, and wherein the second protocol is a PCIe (Peripheral Component Interconnect Express) protocol.

14. A method comprising:
receiving first signals according to a first protocol for accessing a storage subsystem having storage devices;
receiving second signals according to a second, different protocol for accessing the storage subsystem; and
providing, by a multi-protocol multiplexer, the first and second signals to a connector, wherein the first signals are to be routed over a first subset of channels of an interconnect to the storage subsystem, and the second signals are routed over a second subset of channels of the interconnect.

15. The method of claim 14, further comprising:
mapping, by the multi-protocol multiplexer, different input/output (I/O) technologies of storage devices in slots of the storage subsystem; and
configuring I/O circuitry of the multiplexer according to the mapping, wherein the I/O circuitry is to provide signals having a first characteristic to the first subset of channels, and to provide signals having a second, different characteristic to the second subset of channels.
